(19) United States
(12) Patent Application Publication
(10) Pub. No.: US 2003/0033195 A1
(43) Pub. Date: Feb. 13, 2003

(54) Retail site location void analysis system and method

(76) Inventors: Dan E. Bruce, Greenville, SC (US); David S. Bunten, Greer, SC (US)

Correspondence Address: MCNAIR LAW FIRM, P.O. BOX 10827, GREENVILLE, SC, 29603-0827, US

(21) Appl. No.: 10/163,224

(22) Filed: Jun. 5, 2002

Related U.S. Application Data
(60) Provisional application No. 60/296,235, filed on Jun. 6, 2001.

(51) Int. Cl. G06F 17/60

(52) U.S. Cl. 705/10

(57) ABSTRACT

This invention is a system and method for calculating the difference in a subject retailer's ability to satisfy consumer demand within a given geographic area. In calculating the difference in demand, this invention takes into consideration the associations between supply points, origins of demand, market share of competitors and subject retailers, and product decay to provide optimal locations for the placement of additional locations for the subject retailer.

### FIELD OF THE INVENTION

This invention is directed to a computerized system and method for performing geodemographic and behavioral analysis on a specific population set to determine the optimum physical location for placement of retail establishments and particularly for multi-site users.

This application claims priority from Provisional Application Serial No. 60/296,235 filed on Jun. 6, 2001.

### BACKGROUND OF THE INVENTION

In the retail environment, one of the most difficult decisions for any retailer is the determination of physical store placement. This is especially true for large chains with strong competitors such as, Lowe's, Home Depot, Cracker Barrel, BJ's Wholesale, and other multi-site retailers (MSU). When a decision to open a store or close a store (the candidate site) is made, the ramifications are tremendous and capital expenditures or losses easily reach into the millions of dollars. In determining store placement, the factors that should be considered include the purchasing behavior of the community surrounding the site, the transitory nature of the community, the economic health of the community, the existence of competitors, the effect of competitors, and any cannibalization effect exerted by or on the candidate site. Presently, the best data available to predict the effect of the above factors is the purchasing habits as collected by the retailer at the point of sale (POS). Capturing such demand information provides a historical representation of demand information and shows sales as a function of store location. However, specific customer information, such as age, income, address or the demographics may not be included and, therefore, the source of origin of customer demand is not known. Even when the POS information is available, it may only be available for the subject retailer and not for the competitors of the subject retailers. POS information is closely guarded in the retail field.

Even were POS information available for both the subject retailer and the competitors, using this data to accurately predict the demand of a candidate site does not consider the cannibalization of the subject retailers' candidate site. Simply put, using POS data, even with specific customer information, does not account for cannibalization.

One disadvantage of traditional systems, the failure to account for the source of origin, reduces the accuracy of any predictions and makes conclusions drawn from the available data less reliable. Origin of demand is the physical location where a demand for a product or product group is attributed. For example, one site may receive a majority of its customers, and therefore demand, during working hours or when consumers are on their way home, while another location, or supply point, may receive a majority of its customers from shopping trips originating from home. A store downtown would have a customer base resembling the work force of the downtown area while a store in the suburbs would have a customer base resembling the residential population. POS information does not indicate the source of origin, but only determines how many people and how many dollars were spent in the store. The correlation between POS data and the geodemographic data is very different between supply of the store and demand of the customer. To compound the problem, the purchasing habits and source of origin may vary not only between store locations but also by product group. A customer may be more inclined to buy clothing and apparel while at work, or leaving work, but more inclined to buy perishable groceries closer to home.

Prior to this invention, the POS data and analysis was the best method available to determine the purchasing habits and potential customer base of a proposed candidate location. Retailers collect this information at each of their stores and construct databases of this information. Retailers also attempted to combine POS data with demographic information to provide a snapshot of the consuming public relevant to that location. However, this method ignores the source of origin for consumer demand. Additionally, the retailer would only have POS data for its stores and not its competitors. Therefore, the subject retailers would be unable to determine the effect of the competitors on a candidate location.

Concerning third parties to the retailers and their competitors, the POS data, being a closely guarded secret, would not be available to a real estate broker nor would such an entity have any way to obtain this information. As such, the third party cannot use the traditional methods of analysis to predict where a retailer would put its next location. Obviously, a real estate broker would be very interested in this information.

Accordingly, it is an object of this invention to provide a computerized system of determining optimum locations of retail locations to be placed by subject retailers.

It is yet another object of this invention to provide a computerized system to determine the optimum locations for candidate stores while taking into consideration the effect of cannibalization.

It is yet another object of this invention to provide a computerized system to analyze the origin of demand in the determination of the effect on demand of a candidate site.

### SUMMARY OF THE INVENTION

The above objectives are accomplished according to the present invention by providing a system for determining optimal placement of retail establishments according to consumer supply and demand having a computer readable medium; a set of demand information embodied within the computer readable medium representing the consumer demand within a predetermined geographic area; a set of supply information embodied within the computer readable medium representing at least one supply point, the set of supply information including supply point capture criteria representing the ability of at least one supply point to capture the consumer demand; a set of baseline instructions embodied within the computer readable medium for calculating a baseline demand flow according to the set of demand information and the set of supply information; and, a set of analysis instructions embodied within the computer readable medium for receiving a set of candidate point information representing the ability of at least one candidate point to capture the consumer demand, calculating candidate demand flow according to the set of candidate point information, the set of demand information, and the set of supply information, and, comparing the candidate demand flow with the baseline demand flow so that changes in the demand captured of the existing supply points by adding at least one candidate point to the geographic area of the set of demand information is provided.

Residential demand information can be included within the set of demand information representing consumer demand associated with the physical location of consumer residences and representing consumer demand originating from the residences. The residential demand information can be organized by clusters representing the probability as to whether the physical location of consumer residences fall within the cluster. Work demand information can be included within the set of demand information representing consumer demand associated with the physical location of consumer workplaces and representing consumer demand originating from the workplaces. The work demand information can include information representing standard industry codes and standard occupation codes. Commute demand information included within the set of demand information representing consumer demand associated with the physical travel path of the commute between consumer's residences and workplaces. The commute demand information can include information representing a predetermined geographic area surrounding the shortest drive path between residence locations and workplaces.

The set of demand information and set of supply information can be organized by predetermined product groups. Therefore, the set of analysis instructions can include instructions for calculating candidate demand information for at least one candidate point for each of the predetermined product groups so that the effect of adding at least one candidate point to the geographic area analyzed is determined by the predetermined product group.

A set of decay information can be embodied within the computer readable medium representing the reduction in consumer demand according to decay by product groups. Using such information, the set of baseline instructions can include instructions for calculating baseline demand flow according to the set of decay information and the set of analysis instructions can include instructions for calculating candidate demand flow according to the set of decay information. The set of analysis instructions can include instructions for converting the comparison of the candidate demand flow with the baseline demand flow into a monetary expression so that the monetary effect of adding at least one candidate point is provided.

A set of attractor and detractor information can be embodied in the computer readable medium representing potential attractions and detractors associated with particular supply sources represented within the supply information. The set of baseline instructions can include instructions for calculating baseline demand flow according to the set of attractor or detractor information and the set of analysis instructions include instructions for calculating candidate demand flow according to the set of attractor or detractor information. The attractor information can include activity generator information representing activity generators associated with the particular supply sources.

The set of supply information can include subject supply point information and competitor supply point information so as to distinguish between subject supply points and competitor supply points. The baseline instructions can include instructions for determining subject baseline demand flow representing the demand captured by subject supply points prior to introducing any candidate points and the analysis instructions include instructions for calculating any changes in subject baseline demand flow upon comparing the baseline demand flow with the candidate demand flow so that changes in demand capture for the subject supply points is provided illustrating the effect on the subject supply points when adding at least one candidate point to the geographic area analyzed.

This invention can also contain a set of candidate point information representing a plurality of potential candidate points associated with a specific geographic location, the set of candidate point information having candidate point capture information associated with each of the potential candidate points representing the ability of each potential candidate points to capture the consumer demand. The set of baseline instructions embodied within the computer readable medium can calculate a baseline demand flow according to the set of demand information and the set of supply information and the set of analysis instructions embodied can calculate candidate demand flow according to the set of candidate point information, the set of demand information, and the set of supply information and compare the candidate demand flow with the baseline demand flow so that the effect of placement of a candidate point in a specific geographic location to the baseline demand flow is provided to show beneficial locations for placement of supply points.

### DESCRIPTION OF THE DRAWINGS

The invention will be more readily understood from a reading of the following specifications and by reference to the accompanying drawings forming a part thereof, wherein an example of the invention is shown as follows:

FIG. 1 is a schematic illustrating the various database information;

FIG. 2 is a schematic illustrating the data layers within various databases;

FIG. 3 is a schematic illustrating demand points and supply points;

FIG. 4 is a schematic illustrating a demand point, supply points, and a candidate point;

FIG. 5 is a surface map representing the output of the invention; and,

FIG. 6 is a flow chart of this invention.

### DESCRIPTION OF THE PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable code embodied in a computer readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

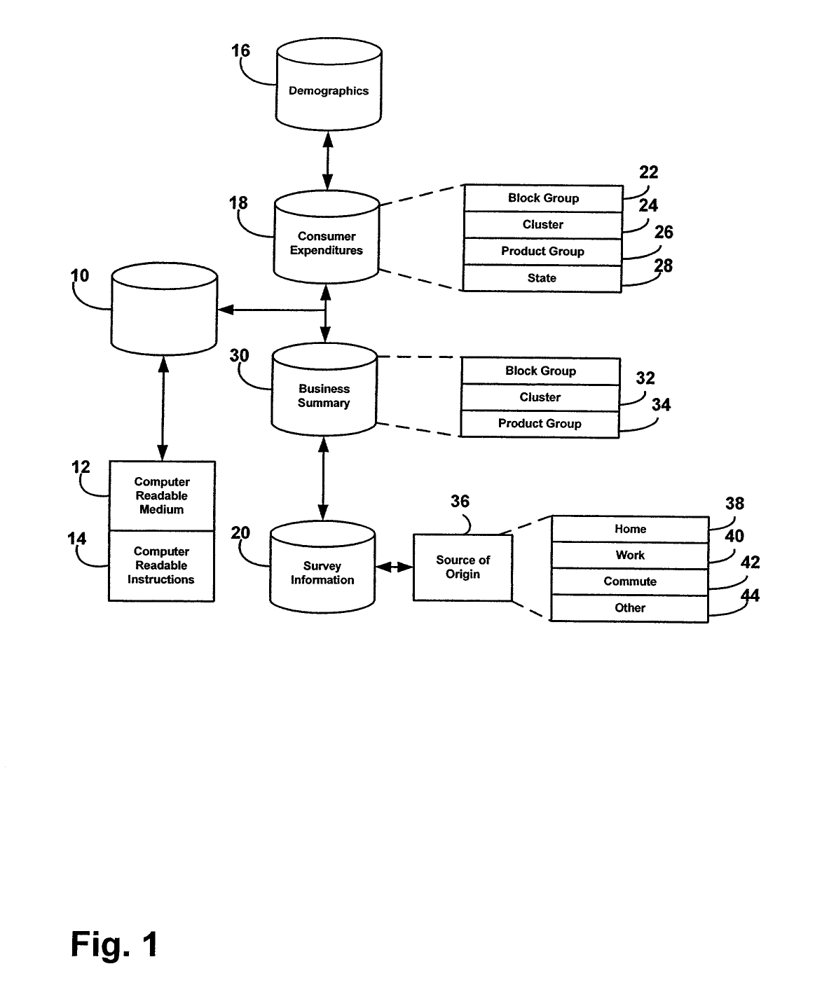

Referring now to FIG. 1, this invention is comprised of two major components, a specialized database including geodemographic information, consumer demand, and supply point capture criteria 10 embodied in a computer readable medium and a set of computer readable instructions for processing various input and providing various output. As for the first aspect of this invention, the best method for explaining this invention to those skilled in the art is by a description of the information collected, stored and manipulated as part of this invention.

Demand and other information stored in database 10 includes demographic information 16 such as age and income; consumer expenditure data 18 representing consumer purchasing behavior; buying activity data such as produced by a census of retail trading; and survey data 20. The above information is used to calculate the consumer demand for products. However, consumer demand information is traditionally organized by block group 22 so that the location of the demand is known, but where the actual demand dollar is spent is not known. A block group is typically defined as a number of households that are deemed to have homogenous consumer purchasing characteristics or a homogeneous demand per product group. However, this definition of a block group assumes that each household has the same characteristics as every other household in the block group. In one embodiment, block group organization is not used for the organization of demand location, but rather a probability that a household falls into a particular cluster 24 is used. A cluster is a market segment with a predetermined set of criteria. For example, a cluster may be an upscale community defined by large household incomes, teenage children living at home, large older dwellings, occupied by business owners and executives. Another cluster may be household residence with ages greater than 65, very low household incomes, high-rise buildings with a large part of income due to governmental subsidies. Each of these clusters has predictable buying habits and characteristics. Additionally, the data can include information by product group 26.

A business summary file 30 is also included in database 10 and also contains information organized by block group, as well as standard industry code (SIC) 32 and stand and occupation code (SOC) 34. The information includes the number of establishments by SIC, number of employees by SIC, and number of employees by SOC. This information is also organized geographically so that the information can be used to determine the amount of consumers attributable to workers demand and the location of this demand from the work force. This demand information is used to represent the demand dollar spent when the shopping trip originates from the workplace.

Supply information is also collected and stored in database 10 concerning the estimated retail sales, across product categories 26, by state 28 for the subject MSU. For example, if the subject retailer were Home Depot, the information collected would be for home improvement products. This information is available for each retailer and stored in the database of this invention. Such information is the supply point criteria used to represent the ability of a MSU to capture demand as explained later. Consumer preference for one MSU over another can be quantized and stored in a database. For example, one MSU may have twice the ability to capture demand based on name recognition than another and a value for name recognition for this MSU would be twice that of its competitor.

To overcome the disadvantage that data is based upon residential block groups, National Family Opinion (NFO), a well-known survey company, custom developed surveys and collected the survey results 35. It should be understood that the collection of survey information through custom surveys need not necessarily be performed by NFO, but can be designed, implemented and data collected by any number of survey companies. The source of origin information was collected by physical point of origin for each shopping trip for each product group to further retire consumer demand. Each shopping trip is categorized by the physical points of origin or source of origin 36. The categories of the demand information are defined as Home, Work, Commuting, and Other. “Home” means the shopping trip originates from the consumer's residence. “Work” means the shopping trip originates from the location of the consumer's workplace. “Commute” is defined as the physical space or geographic area calculated on the shortest drive time path, plus some predetermined distance around the path, between Home and Work. The area encompassed by “Commute” is the domain where the individual initiates purchases of goods during the trip between Home and Work. To calculate the commute domain, the shortest drive distance between the residence and the work location is determined. From this path, a distance away from the path is then determined creating a perimeter around the path. The area defined within the perimeter is the commute domain and purchases made from within the commute domain are classified as having a source of origin of commute. “Other” means a source of demand that is not covered by the other three sources of demand. However, Other is not merely a catch all, but includes traffic points and other activity generators. An activity generator is any location that generates consumer traffic. Such locations include enclosed malls, shopping centers, parks, schools, and other locations where consumers are attracted. Once the locations are determined, traffic counts are performed to associate the number of potential consumers that can be attributed to an activity locator. Traffic points are areas that, for some reason or another, generate consumer traffic so as to potentially generate consumer dollars being spent by merely having the consumer in proximity to a supply point.

From the survey results 35, demand information is collected and recorded concerning the buying habits, or demand, for each of the sources of origin. This the four sources of origin for Home 38, Work 40, Commute 42, and Other 44. The categorization of the cumulative demand is stored by geographic area in database 10.

For the above sources of origin databases, information is collected per major product categories such as food, apparel and hardware in order to account for different purchasing habits relative to the types of products. An example of the NFO survey information is shown tabulated below:

| | Total | Home | Work | Commute | Other |
|---|---|---|---|---|---|
| Category | $ | % | % | % | % |
| Restaurants | 517 | 60 | 31 | 5 | 4 |
| Groceries | 427 | 80 | 15 | 4 | 1 |
| Alcoholic Beverages | 93 | 32 | 47 | 210 | 1 |
| Apparel | 298 | 20 | 40 | 30 | 10 |
| Reading Material | 43 | 29 | 42 | 10 | 19 |
| Office Supplies for home | 1,469 | 81 | 11 | 5 | 3 |
| Office Supplies for work | 2,947 | 4 | 43 | 39 | 14 |
| Furniture | 947 | 89 | 2 | 4 | 5 |
| Appliances | 74 | 63 | 31 | 1 | 5 |
| Toys and Games | 119 | 72 | 21 | 2 | 5 |

These results may show that for a given month the total groceries purchased category was $427. Of this amount, eighty (80%) percent of the individuals, by way of example, purchased items on shopping trips originating from home; fifteen (15%) percent purchased items during their commute; and four (4%) percent purchased items while at work. On the other hand, for the category apparel, $298 was purchased during the month with twenty (20%) percent originating from home; forty (40%) percent from work; thirty (30%) percent during their commute; and ten (10%) percent from other. Similar information is collected for the other product and source of origin categories.

When conducting the survey, demographic information is collected for each of the survey participants. In collecting the above information, the associated demographic information for each survey participant can be related or associated with the survey results. Therefore, the survey participants can be categorized into clusters. When aggregated by cluster and product group, the total spent and the separation by source of origin is determined by each cluster by product group and can be represented in the following grid:

| | Product 1 | | | | | Product 2 | | | | | Product 3 | | | | | * * * | | | | |
|---|---|---|---|---|---|---|---|---|---|---|---|---|---|---|---|---|---|---|---|---|
| Cluster | $ | H | W | C | O | $ | H | W | C | O | $ | H | W | C | O | $ | H | W | C | O |

1
2
3
4
* * *

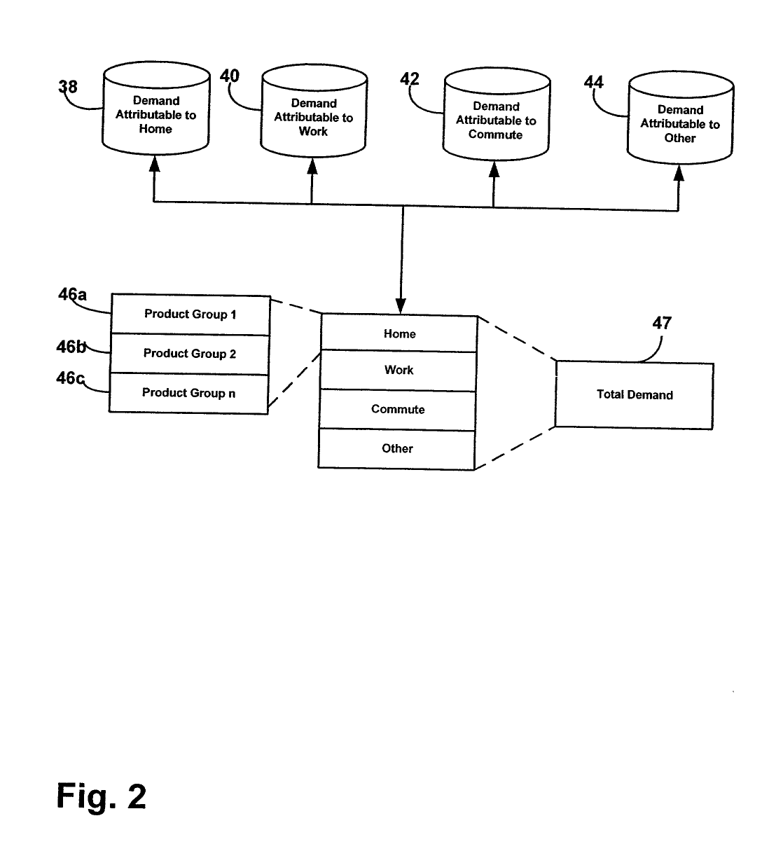

In the above grid,“$” shows the total dollars spent per product, per cluster. The columns, “H”,“W”, “C”, “O” contain the % of the total dollars spent for each of the sources of origin. The above information allows for the traditional demand information to be distributed amongst the sources of origin as well as clusters. Previously, there was no allocation or physical correlation of demand to supply. By using the source of origin for demand and distributing traditional residential based demand, the demand can be distributed across the sources of origin, as shown in FIG. 2. Since each retailer is only concerned with certain product groups, a source of origin layers for that subject retailer would only contain information for those relevant product groups shown as 46a, 46b, and 46c for n product groups.

For example, a lumberyard would not be concerned with milk sales nor would a grocery store necessarily be concerned with lumber sales. Therefore, the information is retrieved only as needed for each subject retailer. The product group demand can be collapsed into source of origin demand and, in turn, the source of origin demand can be collapsed into total demand 47 relevant to the subject retailer in the specified geographic area. Since each of the sources of origin can be converted into latitude and longitude, we can arrive at a dollar by product by latitude and longitude point ($×Product×Lat/Long). This data set can be represented by a layer with an axis for demand, latitude, and longitude. The following chart illustrates the demand points for a specific geographic area. For illustrative purposes, only a limited number of demand points are shown as the actual number of demand points can reach into the millions. In an alternative embodiment, the demand points can be aggregated so as to reduce the number of demand points in order to simplify the calculations performed by the computer readable instructions and to reduce processing time.

[image]

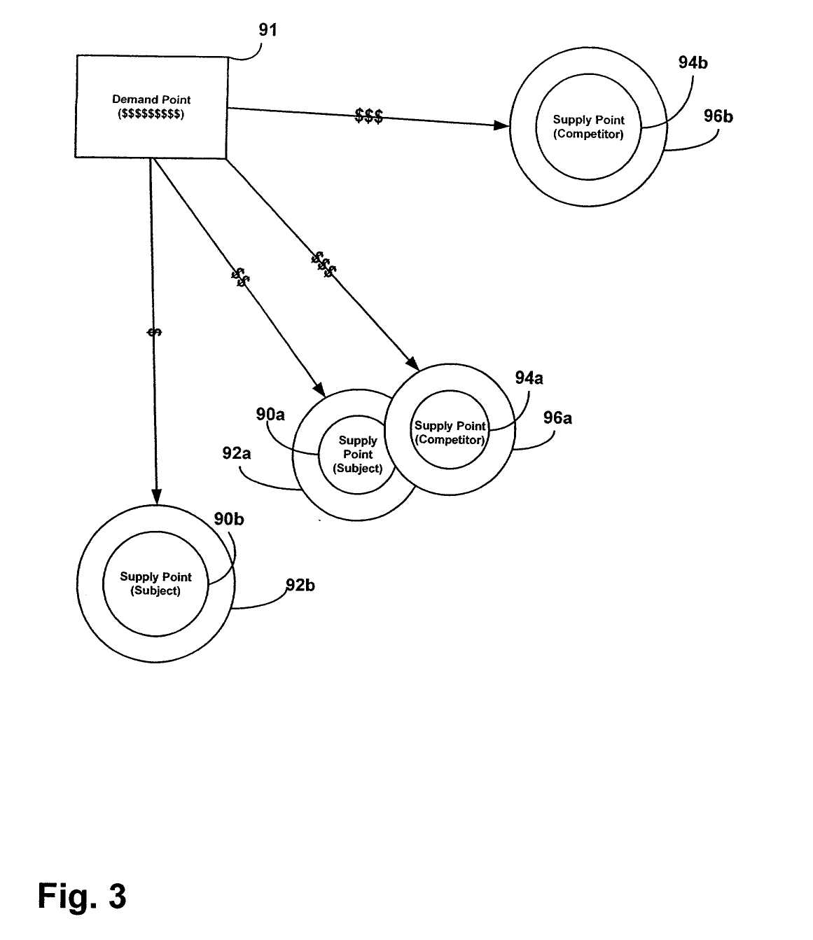

Once this information is retrieved, the subject retailer has a known demand for the relevant products over a specific geographic area. The next task is to allocate this known demand to the existing supply points. Supply points are those locations that supply the product or product groups that are relevant to the subject retailer. FIG. 3 illustrates four supply points with the subject retailer shown as 90a and 90b and a competitor shown as 94a and 94b. As explained later, a candidate point is a proposed supply point inserted into the model of existing supply points to study the changes in the way demand is captured based upon the insertion of the candidate point. A baseline demand flow is a representation of how each supply point captures demand prior to the insertion of any candidate point. The baseline demand flow represents the current state of the consumer supply and demand relationship for a particular geographic area.

In calculating the baseline demand flow, the relevant demand is allocated to the supply points that are able to capture such demand. When performing such analysis, several considerations exist. First, product decay must be considered. Product decay describes the relationship between the type of product and the distance a consumer is willing to travel to obtain that specific product, i.e., to spend demand dollars on the product. For example, a consumer may be willing to drive five miles to purchase milk, but would not drive fifty miles for the purchase. However, a consumer may drive fifty miles or more to purchase a luxury automobile. This information can be illustrated, per product group, by demand probability, against drive time, as shown in the following table.

[image]

As the product decay is more acute, for example as with milk, the curve will move in a direction B while product decay that is less acute, the curve moves in direction A.

In addition to product decay, the effect of attractors and detractors can be considered. An attractor is a store, location or other effect that pulls product demand towards it, while a detractor would push product demand away as shown below. Again, distance is a factor, as well as those elements, which would increase or decrease attractiveness.

[image]

For example, when considering a grocery store to attract demand, An attractor considered an attractor since a pharmacy in proximity to a grocery store tends to increase the grocery store's ability to capture demand. On the other hand, a large enclosed mall would be considered a detractor for the same grocery store since it would tend to lessen the ability of the grocery store to attract demand. An attractor tends to affect the magnitude and slope of the attractiveness curve in an upward direction, as shown above, while a detractor tends to affect the curve in a downward direction. Additionally, attractors can include branding, reputation, or other factors that increase the ability of a supply point to attract or capture demand.

Another factor considered when performing allocation of demand to supply is the market share of the supply point. Market share is entered using product coefficients and affects the ability of a supply point to capture demand. Simply, the larger the market share of the supply point, the greater the supply point can attract demand.

The culmination of these factors, product decay, attractiveness, detractiveness, and market share determine the ability of a supply point to capture consumer demand. Therefore, the following table represents the ability of a supply point, whether it is a competitor, candidate point, or the subject retailer to capture demand. As shown, the ability of a supply point to capture demand decreases with distance. As can also be seen, the greater the supply point can capture demand, the higher the curve.

[image]

By using the above supply and demand information, the subject retailer as is shown in FIG. 3 as being in two locations, 90a and 90b, respectively. By culminating the above factors, each supply point representing the subject retailer, can be said to be able to capture demand within the radius of 92a and 92b, respectively. Understanding that the illustration shows a hard border, the area of capture tapers off based upon distance and other factors as shown in the above graph. For illustrative purposes, however, the radius of FIG. 3 is shown with a hard border.

Also illustrated on FIG. 3 are two competitor supply points 94a and 94b, respectively. The ability to capture demand for these supply points is shown as 96a and 96b, respectively. Based upon the ability of each supply point to capture demand, each demand dollar from demand point 91 is allocated to a supply point. Although FIG. 3 shows only demand point 91, it is to be understood that there can be millions of supply points for a given geographic area. The demand attributed to the subject retailer can be represented as S1₀ for the demand of store 90a without considering candidate points. The demand for store 90b can be represented as S2₀. The total demand for the candidate retailer is S1₀+S2₀ in our example. In the present embodiment, the allocation is performed for every demand point for each of the four sources of origins and aggregated at the supply point. This analysis results in the baseline demand flow.

The baseline demand flow represents the value of the composite demand for each product group for the subject retailer as it exists without consideration of any candidate points. Only the products sold by the subject retailer need be included since only those products determine the demand for the retailer's goods. The baseline is a snapshot of the present demand of the market area being analyzed and includes the subject retailers existing stores as well as those of competitor's stores. The demand allocated to each existing store for the subject retailer is based upon the addition of consumer demand for the relevant product categories of the subject store, or S1₀+S2₀ . . . SN₀ where the demand allocated to store N for the baseline case 0 is SN₀. The total demand, illustrated as D₀, for the subject retailer would then be D₀=Σ_{N}SN₀ where N is the number of stores for the subject retailer. In order to calculate SN₀, the demand, as stored and described above is distributed across the existing stores of the retailer and any competitors. The distribution is based upon the product decay, the market share of the retailer and competitors, attractors and detractors.

To arrive at the baseline demand flow, the demand for the subject retailer is calculated through computer readable instructions represented by the equation Tᵢⱼ=(Aⱼ*dᵢⱼ)/ΣᵢΣⱼ (Aⱼ*dᵢⱼ) where Tᵢⱼ is the representation of demand flow between demand origin i and supply j. The variable Aⱼ represents the ability of the supply point j to capture demand. The variable dᵢⱼ represents the distance between i and j. In an alternative embodiment, a scaling parameter can be included in the supply information for regulation of the magnitude of flow between demand point i and supply point j can be added so that the equation would appear as k (Aⱼ*dᵢⱼ)/ΣᵢΣⱼ(Aⱼ*dᵢⱼ). When the corresponding computer readable instructions are executed, the results of the above calculations are the baseline demand flow for the subject retailer.

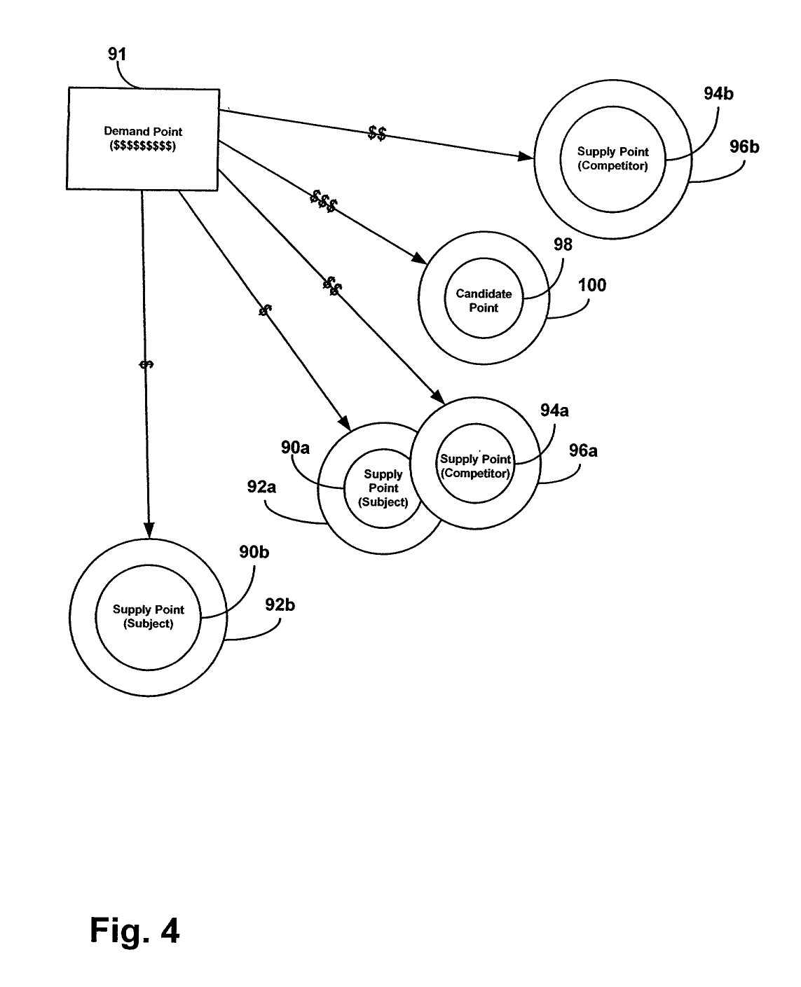

Next, a candidate point is inserted and shown as 98 of FIG. 4. The ability of candidate point 98 to capture demand is shown as 100. The above calculations are performed to discover the demand for the candidate point C₁, as well as to recalculate the demand allocated to subject stores 90a and 90b and competitor 94a and 94b. The demand for the existing supply points for the subject retailer is then calculated and represented by D₁=Σ_{N} SN₁. The total demand, including the candidate point, for the subject retailer is D₁=C₁+Σ_{N} SN₁. If D₁ is greater than D₀, the subject retailer would increase demand by placing a store at candidate point one. In our example, subject retailer supply point 90b still captures one demand dollar. However, supply point 90a has been reduced from previously capturing two demand dollars to one demand dollar showing that the insertion of candidate point 98 has a detrimental effect on this supply poin's ability to capture demand. Beneficially, though, candidate point 98 captures three demand dollars. Therefore, while D₀ was three demand dollars in this example, D₁ is five demand dollars showing that overall, the subject retailer benefits by placing a store at candidate point 98. It should be noted that while C₁ could increase, cannibalization may cause S₁ to decrease resulting in a D₁ that would not be greater than D₀. Therefore, this invention accounts for cannibalization.

While the above shows one candidate point, this invention can be used for a plurality of candidate points. Therefore, a data set of of D₁ to Dₓ is produced for x candidate points. Since each candidate point has an associated latitude and longitude, a three dimensional map can be produced showing where the candidate points having the highest overall demand increase for the subject retailer are located. Therefore, the specific physical location can be determined and the subject retailer can decide whether to purchase real estate or build a store to increase its aggregate ability to meet consumer demand.

In this alternative embodiment, this invention is used to determine the potential for placement of retail establishments without having to specifically have a predetermined candidate point. Instead, a predetermined selection of test points can be used so as to test predetermined locations to see the overall effect of demand flow based upon each of the test points having a supply point and ultimately, the effect of a subject retailer's ability to meet the consumer demand, For example, a third party may wish to construct a retail mall. Since the financial success of the retail mall would largely depend upon the retailers that decided to lease space with the mall, the mall owner would like to secure tenants as early as possible. Therefore, the mall owner may like to construct the mall in a physical location so as to advantageously attract and keep MSU's as tenants. The mall owner would merely have to, for an area where the mall owner can buy or lease land, determine the increase in demand for a MSU were that MSU to be located where the mall was to be built. With such information, the mall owner can select a location to maximize his ability to secure a MSU as a tenant.

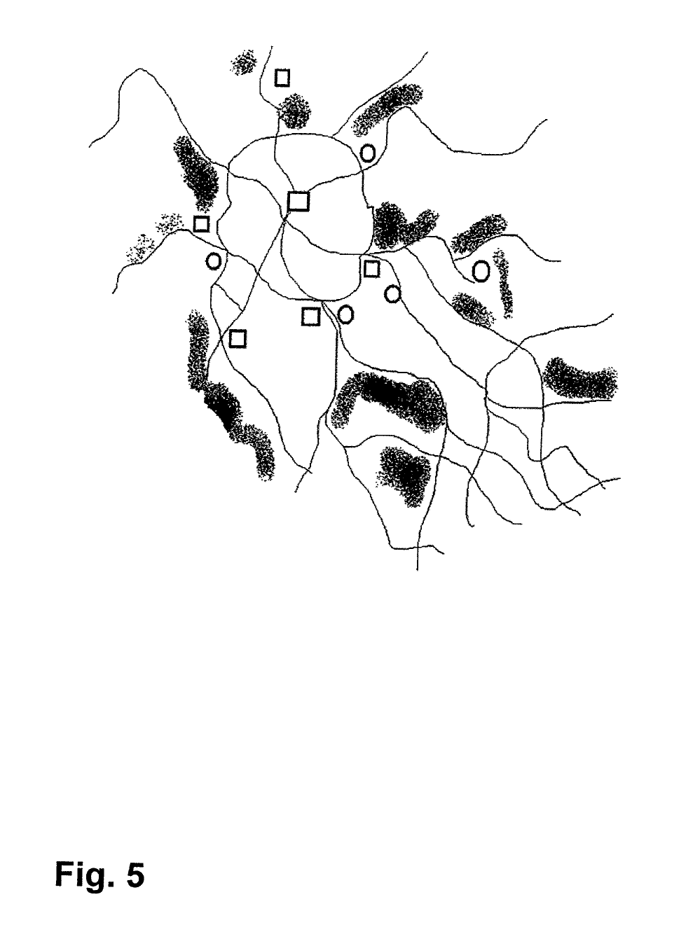

In FIG. 5, the mapped output is illustrated showing areas 84a-84n with the largest probability of increasing demand for the subject retailer were a physical location placed in these areas. Areas such as 84m and 84n represent less desirable areas since there is a lesser ability to capture demand in such areas as opposed to areas like 84k, 84i and 84l. It is clear that the mall owner in the example above, would much prefer to build a mall where the demand is increased rather than where lesser demand satisfaction would occur. Additionally, the subject retailer is informed as to the best locations in which to place a store to increase the overall demand and sales for the subject retailer.

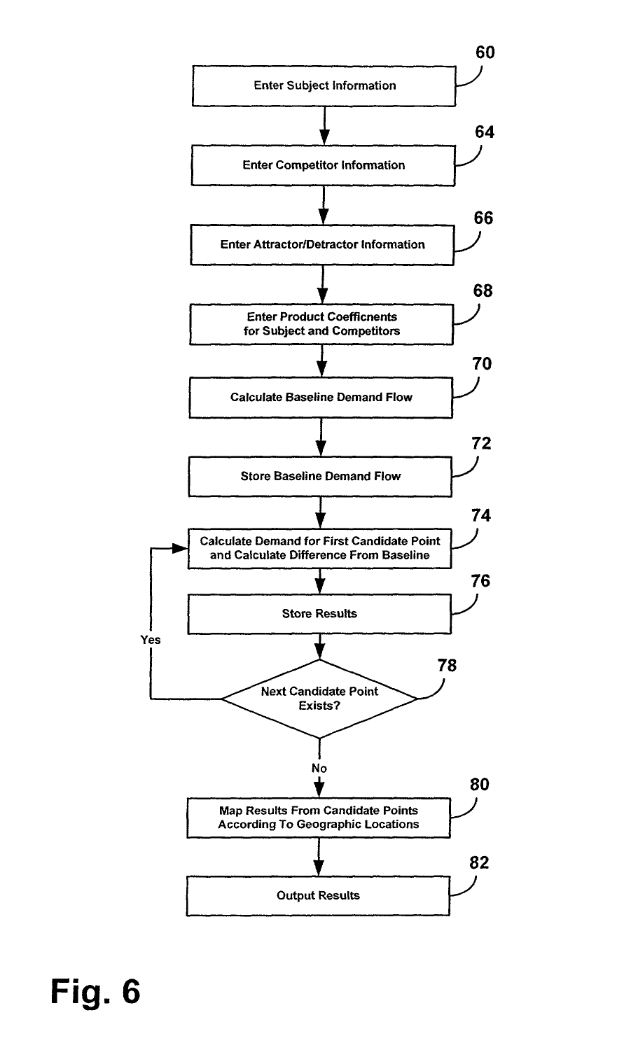

In executing this invention, the subject retailer information is entered or retrieved at step 60 of FIG. 6. Competitors' information is entered or retrieved at step 64 and the ability of the supply points to capture demand supply information is entered at step 66. The market share of any subject or competitors and distance decay is entered at step 68. The baseline demand flow, without candidate points, is then determined and demand is allocated to existing supply points for each source of origin at step 70. The resulting baseline demand flow is stored at step 72. The computer readable instructions are then executed, but with the inclusion of a candidate point at step 74 and the results in demand capture from the effect of the candidate point or points, or test points are stored at step 76. The candidate point results are calculated for each possible candidate point or test point till all candidate points or test points are exhausted at step 78. The results from each candidate point or test point is then stored with its associated latitude and longitude at step 78 and outputted to the user of the invention at step 82.

While a preferred embodiment of the invention has been described using specific terms, such description is for illustrative purposes only, and it is to be understood that changes and variations may be made without departing from the spirit or scope of the following claims.

What is claimed is:

1. A system for determining optimal placement of retail establishments according to consumer demand comprising:
a computer readable medium;
a set of demand information embodied within said computer readable medium representing consumer demand within a predetermined geographic area;
a set of supply information for at least one supply point embodied within said computer readable medium having supply point capture criteria representing the ability of said at least one supply point to capture said consumer demand;
a set of computer readable baseline instructions embodied within said computer readable medium for calculating a baseline demand flow according to said set of demand information and said set of supply information; and,
a set of computer readable analysis instructions embodied within said computer readable medium for receiving candidate point information representing the ability of at least one candidate point to capture said consumer demand, calculating candidate demand flow according to said candidate point information, said set of demand information, and said set of supply information, and, comparing said candidate demand flow with said baseline demand flow so that changes in the demand captured by at least one of said supply point due to adding at least one candidate point to the geographic area of said consumer demand is provided.

2. The system of claim 1 including residential demand information included within said set of demand information representing consumer demand associated with the physical location of consumer residences and representing consumer demand originating from said residences.

3. The system of claim 2 wherein said residential demand information is organized by clusters representing the probability as to whether the physical location of consumer residences fall within said cluster.

4. The system of claim 1 including work demand information included within said set of demand information representing consumer demand associated with the physical location of consumer workplaces and representing consumer demand originating from said workplaces.

5. The system of claim 4 wherein said work demand information includes information representing standard industry codes and standard occupation codes.

6. The system of claim 1 including commute demand information included within said set of demand information representing consumer demand associated with the physical travel path of the commute between consumers' residences and workplaces.

7. The system of claim 6 wherein said set of commute demand information includes information representing a predetermined geographic area surrounding the shortest drive path between residence locations and workplaces.

8. The system of claim 1 wherein:
said set of demand information includes consumer demand information organized by predetermined product groups;
said set of supply information is organized by predetermined product groups; and,
said set of analysis instructions include instructions for calculating candidate demand information for at least one candidate point for each of said predetermined product groups so that the effect of adding at least one candidate point to the geographic area analyzed is determined by said predetermined product groups.

9. The system of claim 8 including:
a set of decay information embodied within said compute readable medium representing the reduction in consumer demand according to decay by product group;
said set of baseline instructions include instructions for calculating baseline demand flow according to said set of decay information; and,
said set of analysis instructions include instructions for calculating candidate demand flow according to said set of decay information.

10. The system of claim 1 wherein said set of analysis instructions include instructions for converting said comparison of said candidate demand flow with said baseline demand flow into a monetary expression so that the monetary effect of adding at least one candidate point is provided.

11. The system of claim 1 including:
a set of attractor information embodied in said computer readable medium representing potential attractions associated with particular supply sources represented within said supply information;
said set of baseline instructions include instructions for calculating baseline demand flow according to said set of attractor information; and,
said set of analysis instructions include instructions for calculating candidate demand flow according to said set of attractor information.

12. The system of claim 11 wherein said set of attractor information includes activity generator information representing activity generators associated with said particular supply sources.

13. The system of claim 1 including:
a set of detractor information embodied in said computer readable medium representing detractors away from particular supply sources represented within said supply information;
said set of baseline instructions include instructions for calculating baseline demand flow according to said set of detractor information; and,
said set of analysis instructions include instructions for calculating candidate demand flow according to said set of detractor information.

14. The system of claim 1 wherein:
said set of supply information includes subject supply point information and competitor supply point information so as to distinguish between subject supply points and competitor supply points;
said baseline instructions include instructions for determining subject baseline demand flow representing the demand captured by subject supply points prior to introducing any candidate points; and,
said analysis instructions include instructions for calculating changes in subject baseline demand flow upon comparing said baseline demand flow with said candidate demand flow so that changes in demand capture for the subject supply points is provided illustrating the effect on the subject supply points when adding at least one candidate point to the geographic area analyzed.

15. A system for analyzing consumer demand according to the addition of at least one supply point comprising:
a computer readable medium;
a set of demand information embodied within said computer readable medium representing consumer demand within a predetermined geographic area;
a set of supply information for at least one supply point embodied within said computer readable medium having supply point capture criteria representing the ability of said at least one supply point to capture said consumer demand;
a set of candidate point information representing a plurality of potential candidate points associated with a specific geographic location, said set of candidate point information having candidate point capture information associated with each of said potential candidate points representing the ability of each potential candidate points to capture said consumer demand;
a set of computer readable baseline instructions embodied within said computer readable medium for calculating a baseline demand flow according to said set of demand information and said set of supply information; and,
a set of computer readable analysis instructions embodied within said computer readable medium for calculating candidate demand flow according to said set of candidate point information, said set of demand information, and said set of supply information and comparing said candidate demand flow with said baseline demand flow so that the effect of adding a candidate point in a specific geographic location is shown to provide beneficial locations for placement of supply points.

16. The system of claim 15 including residential demand information included within said set of demand information representing consumer demand associated with the physical location of consumer residences and representing consumer demand originating from said residences.

17. The system of claim 16 wherein said residential demand information is organized by clusters representing the probability as to whether the physical location of consumer residences fall within said cluster.

18. The system of claim 15 including work demand information included within said set of demand information representing consumer demand associated with the physical location of consumer workplaces and representing consumer demand originating from said workplaces.

19. The system of claim 18 wherein said work demand information includes information representing standard industry codes and standard occupation codes.

20. The system of claim 15 including commute demand information included within said set of demand information representing consumer demand associated with the physical travel path of the commute between consumers' residences and workplaces.

21. The system of claim 20 wherein said set of commute demand information include information representing a predetermined geographic area surrounding the shortest drive path between residence locations and workplaces.

22. The system of claim 15 wherein:
said set of demand information includes consumer demand organized by predetermined product groups;
said set of supply information is organized by predetermined product groups; and,
said set of analysis instructions include instructions for calculating candidate demand flow for each of said predetermined product groups so that the beneficial locations for adding supply points to the geographic area analyzed is determined by said predetermined product groups.

23. The system of claim 22 including:
a set of decay information embodied within said compute readable medium representing the reduction in consumer demand according to decay by product groups;
said set of baseline instructions include instructions for calculating baseline demand flow according to said set of decay information; and,
said set of analysis instructions include instructions for calculating candidate demand flow according to said set of decay information.

24. The system of claim 15 wherein said set of analysis instructions include instructions for converting said comparison of said candidate demand flow with said baseline demand flow into a monetary expression so that the potential beneficial for adding supply points to specific locations are expressed in monetary terms.

25. The system of claim 15 including:
a set of attractor information embodied in said computer readable medium representing potential attractions associated with particular supply sources represented within said supply information;
said set of baseline instructions include instructions for calculating baseline demand flow according to said set of attractor information; and,
said set of analysis instructions include instructions for calculating candidate demand flow according to said set of attractor information.

26. The system of claim 25 wherein said set of attractor information includes activity generator information representing activity generators associated with said particular supply sources.

27. The system of claim 15 including:
a set of detractor information embodied in said computer readable medium representing detractors away from particular supply sources represented within said supply information;
said set of baseline instructions include instructions for calculating baseline demand flow according to said set of detractor information; and,
said set of analysis instructions include instructions for calculating candidate demand flow according to said set of detractor information.

28. The system of claim 15 wherein:
said set of supply information includes subject supply point information and competitor supply point information so as to distinguish between subject supply points and competitor supply points;
said baseline instructions include instructions for determining subject baseline demand flow representing the demand captured by subject supply points prior to introducing any candidate points; and,
said analysis instructions include instructions for calculating any changes in subject baseline demand flow upon comparing said baseline demand flow with said candidate demand flow so that changes in demand capture for the subject supply points is provided illustrating the effect to the existing subject supply points were additional supply points added to the geographic area analyzed.

29. A method for determining optimal placement of retail establishments according to consumer demand comprising the steps of:
providing a set of demand information representing the consumer demand within a predetermined geographic area;
providing a set of supply information for at least one supply point, having supply point capture criteria representing the ability of said at least one supply point to capture said consumer demand;
calculating a baseline demand flow according to said set of demand information and said set of supply information;
receiving a set of candidate point information representing the ability of at least one candidate point to capture said consumer demand;
calculating candidate demand flow according to said set of candidate point information, said set of demand information, and said set of supply information; and,
comparing said candidate demand flow with said baseline demand flow so that changes in the demand captured by the existing supply points from adding at least one candidate point to the geographic area of said set of demand information is provided.

30. The method of claim 29 including the step of providing residential demand information included within said demand information representing consumer demand associated with the physical location of consumer residences and representing consumer demand originating from said residences.

31. The method of claim 30 including the step of organizing said residential demand information by clusters representing the probability as to whether the physical location of consumer residences fall within said cluster.

32. The method of claim 29 including the step of providing work demand information included within said demand information representing consumer demand associated with the physical location of consumer workplaces and representing consumer demand originating from said workplaces.

33. The method of claim 29 including the step of providing commute demand information included within said demand information representing consumer demand associated with the physical travel path of the commute between consumers' residences and workplaces.

34. The method of claim 29 including the steps of:
organizing said set of demand information by predetermined product groups;
organizing said set of supply information by predetermined product groups; and,
calculating candidate demand information for at least one candidate point for each of said predetermined product groups so that the effect of adding at least one candidate point to the geographic area analyzed is determined by said predetermined product groups.

35. The method of claim 34 including the steps of:
providing a set of decay information representing the reduction in consumer demand according to decay by product groups;
calculating baseline demand flow according to said set of decay information; and,
calculating candidate demand flow according to said set of decay information.

36. The method of claim 29 including the step of converting said comparison of said candidate demand flow with said baseline demand flow into a monetary expression so that the monetary effect of adding at least one candidate point is provided.

37. The method of claim 29 including the steps of:
providing a set of attractor information representing potential attractions associated with particular supply sources represented within said supply information;
calculating baseline demand flow according to said set of attractor information; and,
calculating candidate demand flow according to said set of attractor information.

38. The method of claim 37 including the step of including activity generator information within said attractor information representing activity generators associated with said particular supply sources.

39. The method of claim 29 including the steps of:
providing a set of detractor information representing detractors away from particular supply sources represented within said supply information;
calculating baseline demand flow according to said set of detractor information; and,
calculating candidate demand flow according to said set of detractor information.

40. The system of claim 29 including the steps of:
providing subject supply point information and competitor supply point information so as to distinguish between subject supply points and competitor supply points;
determining subject baseline demand flow representing the demand captured by subject supply points prior to introducing any candidate points;
calculating any changes in subject baseline demand flow upon comparing said baseline demand flow with said candidate demand flow so that changes in demand capture for the subject supply points is provided illustrating the effect on the subject supply points when adding at least one candidate point to the geographic area analyzed.

41. A system for determining optimal placement of retail establishments according to consumer demand comprising the steps of:
a means for providing a set of demand information representing the consumer demand within a predetermined geographic area;
a means for providing a set of supply information for at least one supply point, supply point capture criteria representing the ability of said at least one supply point to capture said consumer demand;
a means for calculating a baseline demand flow according to said set of demand information and said set of supply information;
a means for determining a set of candidate point information representing the ability of at least one candidate point to capture said consumer demand;
a means for calculating candidate demand flow according to said set of candidate point information, said set of demand information, and said set of supply information; and,
a means for comparing said candidate demand flow with said baseline demand flow so that changes in the demand captured of the existing supply points by adding at least one candidate point to the geographic area of said set of demand information is provided.

42. The system of claim 41 wherein said set of demand information includes residential demand information representing consumer demand associated with the physical location of consumer residences and representing consumer demand originating from said residences.

43. The system of claim 42 wherein said residential information is organized by clusters representing the probability as to whether the physical location of consumer residences fall within said cluster.

44. The method of claim 41 wherein said demand information includes work demand information representing consumer demand associated with the physical location of consumer workplaces and representing consumer demand originating from said workplaces.

45. The system of claim 41 where in said demand information includes commute demand information representing consumer demand associated with the physical travel path of the commute between consumers' residences and workplaces.

46. The system of claim 41 wherein:
said set of demand information is organized by predetermined product groups;
said set of supply information is organized by predetermined product groups; and,
a means calculating candidate demand information for at least one candidate point for each of said predetermined product groups so that the effect of adding at least one candidate point to the geographic area analyzed is determined by said predetermined product groups.

47. The system of claim 46 including:
a means for providing a set of decay information representing the reduction in consumer demand according to decay by product groups;
a means for calculating baseline demand flow according to said set of decay information; and,
a means for calculating candidate demand flow according to said set of decay information.

48. The system of claim 41 including a means for converting said comparison of said candidate demand flow with said baseline demand flow into a monetary expression so that the monetary effect of adding at least one candidate point is provided.

49. The method of claim 41 including:
a means for providing a set of attractor information representing potential attractions associated with particular supply sources represented within said supply information;
a means for calculating baseline demand flow according to said set of attractor information; and,
a means for calculating candidate demand flow according to said set of attractor information.

50. The system of claim 49 wherein said attractor information includes activity generator information representing activity generators associated with said particular supply sources.

51. The system of claim 41 including:
a means for providing a set of detractor information representing detractors away from particular supply sources represented within said supply information;
a means for calculating baseline demand flow according to said set of detractor information; and,
a means for calculating candidate demand flow according to said set of detractor information.

52. The system of claim 41 including:
a means for providing subject supply point information and competitor supply point information so as to distinguish between subject supply points and competitor supply points;
a means for determining subject baseline demand flow representing the demand captured by subject supply points prior to introducing any candidate points;
a means for calculating any changes in subject baseline demand flow upon comparing said baseline demand flow with said candidate demand flow so that changes in demand capture for the subject supply points is provided illustrating the effect on the subject supply points when adding at least one candidate point to the geographic area analyzed.
